(19) United States
(12) Patent Application Publication
(10) Pub. No.: US 2006/0238716 A1
(43) Pub. Date: Oct. 26, 2006

(54) Light source module and image projection apparatus employing the same

(75) Inventors: Kye-hoon Lee, Suwon-si (KR); Jong-hoi Kim, Suwon-si (KR); Hyun-seung Cho, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/409,999

(22) Filed: Apr. 25, 2006

(30) Foreign Application Priority Data
Apr. 25, 2005 (KR) 10-2005-0034159

(51) Int. Cl. G03B 21/14

(52) U.S. Cl. 353/20

(57) ABSTRACT

A light source module and an image projection apparatus employing the same are provided. The light source module includes: a light-emitting chip installed on a base to generate and emit illuminating light and having reflectivity to reflect light incident on the light-emitting chip; a reflection mirror coupled with the base to reflect the light coming from the light-emitting chip toward a front direction; and a polarization alignment unit installed on an exit end of the reflection mirror to feed back a portion of light incident on the polarization alignment unit by reflection and to polarize the light coming from the light-emitting chip in one direction and output the polarized light, wherein the fed back light of the light incident on the polarization alignment unit is reflected back to the polarization alignment unit by at least one of the reflection mirror and the base.

### CROSS-REFERENCE TO RELATED PATENT APPLICATION

This application claims the priority of Korean Patent Application No. 10-2005-0034159, filed on Apr. 25, 2005, in the Korean Intellectual Property Office, the disclosure of which is incorporated herein in its entirety by reference.

### BACKGROUND OF THE INVENTION

1. Field of the Invention

The present invention relates to an illumination unit and an image projection apparatus employing the same, and more particularly, to an illumination unit that is designed to increase light efficiency and an image projection apparatus providing a brighter screen using the illumination unit.

2. Description of the Related Art

An illumination unit generally includes a light source to emit light and an illumination optical system to transmit the light emitted from the light source. Such an illumination unit is widely used for an image projection apparatus that forms an image using an image forming device, such as a liquid crystal display (LCD), that is not self-luminous.

Since the lifetime of a metal halide lamp or ultrahigh pressure mercury lamp, which is commonly used for the light source of the illumination unit, is several thousand hours at the most, the lamp should be frequently replaced with new one. To eliminate this inconvenience of frequent replacement, research is performed to use small-sized luminous elements, such as a light-emitting diode (LED), having a relatively long lifetime as a light source of the illumination unit.

Since an LED emits diffusion light, the illumination unit should have a collimation function to collect the light emitted from the LED and direct it in a specific direction.

An image projection apparatus using an LED as a light source performs an operation of concentrating light emitted from the LED upon an image forming device. The amount of light concentrated on the image forming device determines overall screen brightness of the image projection apparatus. The quantity of the light that can be concentrated on the image forming device is determined by a product of etendue of the image forming device and the brightness of the LED.

Brightness is flux per unit area or per unit solid angle. Etendue is a product of the light-generating area of the LED (light source) and solid angle of the light emitted from the LED. Ideally, etendue can be conserved such that the product of the light-generating area of the LED and the solid angle of the light from the LED is the same as the product of area of the image forming device and solid angle of the light incident to the image forming device. Etendue of the image forming device is geometrically determined.

Therefore, the brightness of the image projection apparatus can be increased by increasing the brightness of the LED. However, the brightness of the LED is limited due to manufacturing restrictions.

Also, in case of using a transmissive LCD or reflective LCD (e.g., liquid crystal on silicon, LCOS) as the image forming device, at least 50% of input light is lost because of the polarization property of LCD.

Therefore, since radiating brightness of LED itself is limited due to manufacturing restriction, there is a need for increasing the amount of light used as effective light in the image forming device to attain an image projection apparatus with a higher brightness.

### SUMMARY OF THE INVENTION

The present invention provides a light source module and an image projection apparatus employing the same, the light source module being capable of producing collimated and polarized light for an image forming device of the image projection apparatus to prevent light loss resulting from a polarization property of the image forming device.

According to one aspect of the present invention, there is provided a light source module including: a light-emitting chip installed on a base to generate and emit illuminating light and having reflectivity to reflect light incident thereto; a reflection mirror coupled with the base to reflect the light coming from the light-emitting chip toward a front direction; and a polarization alignment unit installed on an exit end of the reflection mirror to feed back a portion of light incident on the polarization alignment unit by reflection and to polarize the light coming from the light-emitting chip in one direction and output the polarized light, wherein the fed back light of the light incident on the polarization alignment unit is reflected back to the polarization alignment unit by at least one of the reflection mirror and the base.

The light source module may further include a lens plate installed between the polarization alignment unit and the light-emitting chip and having a lens at a center portion across an optical path along which some of the light from the light-emitting chip is directly directed to the polarization alignment unit.

The lens may be a convex lens with a focal point on or near a surface of the light-emitting chip, and the lens plate may be made of a transparent material.

The reflection mirror may have a parabolic shape and the light-emitting chip may be placed at or near a focal point of the reflection mirror.

The light-emitting chip may be one light-emitting chip selected from a single light-emitting chip with a normal surface size, a chip array with a plurality of light-emitting chips each having a normal surface size, and a single light-emitting chip with a surface size relatively larger than the normal surface size.

A surface of the base facing the exit end of the reflection mirror may be a reflective surface.

The polarization alignment unit may include: a polarizing plate placed at an exit end of the reflection mirror to pass a first linear polarization component of light incident on the polarizing plate and to feed back a second linear polarization component of the light incident on the polarizing plate that is orthogonal to the first linear polarization component; and a quarter wave plate placed between the light-emitting chip and the polarizing plate to change the polarization of light incident on the quarter wave plate.

The polarization alignment unit may include: a plurality of polarizing beam splitters to selectively transmit or reflect light incident on the polarizing beam splitters based on polarization of the light incident on the polarizing beam splitters; a plurality of reflectors respectively placed near the polarizing beam splitters to form an array structure with the polarizing beam splitters, the reflectors reflecting the light reflected from the polarizing beam splitter to direct the light reflected from the polarizing beam splitter in a parallel direction with the light transmitted through the polarizing beam splitter; a plurality of half wave plates respectively placed on output surfaces of the reflectors to change the polarization of the light reflected from the reflectors; and a plurality of reflecting plates respectively placed on surfaces of the reflectors to face the light-emitting chip, the reflecting plates feeding back light incident on the reflecting plate.

According to another aspect of the present invention, there is provided an image projection apparatus including: at least one light source module according to one aspect of the present invention; an image forming device utilizing polarization receiving light illuminated from the light source module to form an image corresponding to an input image signal; and a projection lens unit projecting the image formed by the image forming device to a screen on an enlarged scale.

A plurality of light source modules may be provided in the image projection apparatus to output light in different colors, and the image projection apparatus may further include: a color synthesis prism combining the color light output from the light source modules to direct the combined light in a single optical path; and a light integrator homogenizing the light output from the light source modules.

The image forming device may be a reflective LCD, and the image projection apparatus may further include a polarization-selecting optical path changer disposed between the light source module and the reflective LCD to selectively transmit or reflect light incident on the polarization-selecting optical path changer based on polarization of the light incident on the polarization-selecting optical path changer so as to direct the light from the light source module toward the reflective LCD and to direct light with image information reflected from the reflective LCD toward a screen.

The image forming device may be a transmissive LCD.

The light integrator may include a pair of fly eye lenses.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view showing a structure of a light source module according to an embodiment of the present invention;

FIG. 2 shows an image projection apparatus employing the light source module depicted in FIG. 1 according to an embodiment of the present invention;

FIG. 3 shows an image projection apparatus employing the light source module depicted in FIG. 1 according to another embodiment of the present invention; and

FIGS. 4A and 4B are schematic views showing a structure of a light source module according to another embodiment of the present invention.

### DETAILED DESCRIPTION OF THE INVENTION

The present invention will now be described more fully with respect to the accompanying drawings, in which exemplary embodiments of the invention are shown.

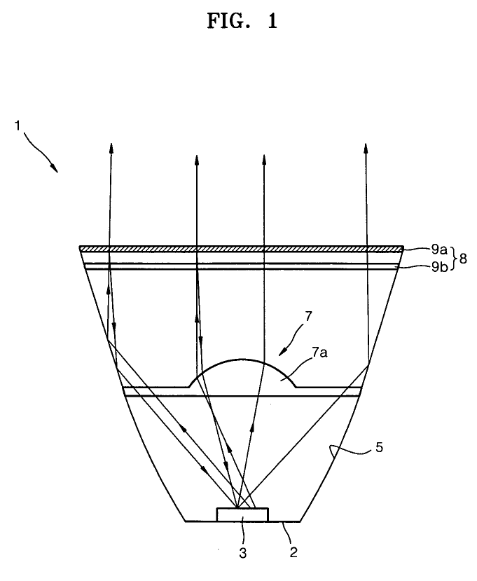

FIG. 1 is a schematic view showing a structure of a light source module 1 according to an embodiment of the present invention.

Referring to FIG. 1, the light source module 1 includes: a light-emitting chip 3 installed on a base 2 to generate and emit illumination light; a reflection mirror 5 to reflect the light coming from the light-emitting chip 3 in a front direction; a polarization alignment unit 8 installed on an exit end of the reflection mirror 5; and a lens plate 7 formed with a lens 7a across an optical path along which the light from the light-emitting source 3 is directly directed to the polarization alignment unit 8.

The light-emitting chip 3 may have a reflectivity to reflect incident light. As is well-known, typical light-emitting chips have a smooth surface having a reflectivity. The light-emitting chip 3 may include an additional reflective layer (not shown) to increase its reflectivity more than the basic reflectivity of a typical light-emitting chip. For example, the reflective layer may be formed between a substrate of the light-emitting chip 3 and a semiconductor layer that is to be stacked on the substrate. With this increased reflectivity, the light-emitting chip 3 can more effectively reflect light fed back from the polarization alignment unit 8 back to the polarization alignment unit 8.

The light-emitting chip 3 may include an LED chip array by neighboring arrayed packaging of a plurality of small LED chips having relatively small surface area, or it may include a relatively large LED chip having a larger surface size than the small LED chip.

The small LED chip having small surface area may be a normal size LED chip (e.g., 1 mm×1 mm LED chip). The LED chip array is a two-dimensional array (n×n) with a plurality of the normal size LED chips. The relatively large LED chip has a larger surface size than the normal size LED chip. The larger surface size the LED chip has, the larger light-emitting active layer the LED has. An LED with a larger surface size generates more light than an LED with a smaller surface size.

When the light-emitting chip 3 includes the LED chip array with the plurality of small LED chips or the relatively large LED chip, the light source module 1 can output more light than the case of using a normal size LED chip.

Alternatively, the light-emitting chip 3 may include a LED chip having a normal surface size. Also, the light-emitting chip 3 may include another type of single light-emitting chip or another type of light-emitting chip array, instead of including the LED chip array or the relatively large LED chip. For example, the light-emitting chip 3 may be formed of a single chip of an organic electroluminescent (EL) or field emission display (FED), or an array thereof.

The light-emitting chip 3 is installed on the base 2. The surface of the base 2 facing the exit end of the reflection mirror 5 may be a reflective surface to reflect light fed back from the polarization alignment unit 8. Since the light-emitting chip 3 is not substantially a point light source but a surface light source, some of the light fed back from the polarization alignment unit 8 can be directed to the base 2 instead of the light-emitting chip 3. Therefore, when the surface of the base 2 is formed as a reflective surface, a ratio at which the fed back light is redirected back to the polarization alignment unit 8 may be enhanced.

The reflection mirror 5 is coupled with the base 2 on which the light-emitting chip 3 is installed. The reflection mirror 5 reflects light coming from the light-emitting chip 3 in a front direction.

The reflection mirror 5 may have a parabola shape, and the light-emitting chip 3 may be placed on a focal point of the reflection mirror 5 or near the focal point. In this case, light emitted from the light-emitting chip 3 and reflected by the reflection mirror 5 is collimated into an approximately parallel light, and it is reflected by the reflection mirror 5. The collimated light, i.e., the approximately parallel light, is not an exact parallel light because the light-emitting chip 3 is not a point light source but substantially a surface light source.

The polarization alignment unit 8 is installed on the exit end of the reflection mirror 5 to feed back a portion of incident light by reflection and to output light that is emitted from the light-emitting chip 3 and converted as a single polarized light.

In this embodiment, the polarization alignment unit 8 is placed at the exit end of the reflection mirror 5 and includes a polarizing plate 9a and a quarter wave plate 9b. The polarizing plate 9a passes a first linear polarization component of incident light and feeds back a second linear polarization component of the incident light, for example, by reflecting it. The quarter wave plate 9b is placed between the light-emitting chip 3 and the polarizing plate 9a to change the polarization.

The polarizing plate 9a may be a reflective polarizer. The reflective polarizer is formed in an isotropic material array, such that it transmits one polarization component of incident light and reflects the other polarization component.

The lens plate 7 is installed between the polarization alignment unit 8 and the light-emitting chip 3. The lens 7a formed at a center of the lens plate 7 is coaxial with the light-emitting chip 3. The lens plate 7 may be made of a transparent material.

The lens 7a may be a convex lens with its focal point on or near a surface of the light-emitting chip 3. Thus, light emitted from the light-emitting chip 3 directly toward the polarization alignment unit 8 is collimated by the lens 7a into an approximately parallel light.

With this recycling structure of the light source module 1, polarized and collimated light can be obtained at an efficiency of at least 50% (ideally, 100%).

That is, the diverging light emitted from the light-emitting chip 3 is converted into approximately straight light by the reflection at the parabolic reflection mirror 5. Also, a center portion of the diverging light emitted from the light-emitting chip 3 is condensed into substantially straight light by the lens 7a of the lens plate 7.

The light emitted from the light-emitting chip 3 is approximately non-polarized light, such that, after passing through the quarter wave plate 9b, a P polarization component (or S polarization component) of the light is transmitted through the polarizing plate 9a and an S polarization component (or P polarization component) of the straight light is reflected by the polarizing plate 9a for feedback. The S (or P) polarized light reflected by the polarizing plate 9a is directed in a reverse direction through the quarter wave plate 9b toward the light-emitting chip 3. The light-emitting chip 3 reflects the redirected S (or P) polarized light again. The redirected S (or P) polarized light reflected by the light-emitting chip 3 is again reflected by the reflection mirror 5 or condensed by the lens 7a, thereby converted as a straight light. This straight light is passed through the quarter wave plate 9b again. The S (or P) polarized light, as it passes through the quarter wave plate 9b, is converted into a P (or S) polarized light because the light passes through the quarter wave plate 9b twice. Therefore, the above fed back light passes through the polarizing plate 9a this time, and thus the light source module 1 can output the P (or S) polarized light at an efficiency of at least 50% (ideally, 100%).

As shown in FIG. 1, the fed back light may be mostly redirected to the polarization alignment unit 8 after being reflected by one portion of the reflection mirror 5, the light-emitting chip 3, and the other portion of the reflection mirror 5 in order. Also, the fed back light may be mostly redirected to the polarization alignment unit 8 after passing through one portion of the lens 7a, reflected by the light-emitting chip 3, and passing through the other portion of the lens 7a in order. That is, most of the fed back light is reflected by the light-emitting chip 3 back and travels toward the polarization alignment unit 8 again.

Even though the light-emitting chip 3 is located on or near the focal point of the parabolic reflection mirror 5, some of the fed back light can be directed to the base 2 instead of the light-emitting chip 3 because the light-emitting chip 3 is not a point light source but a surface light source. Therefore, when the surface of the base 2 facing the exit end of the reflection mirror 5 is treated to be a reflection surface, the ratio at which the fed back light travels toward the polarization alignment unit 8 again may be further increased.

According to this embodiment, polarized and collimated light can be obtained from the non-polarized light emitted from the light-emitting chip 3 at an efficiency of at least 50% (ideally, 100%) owing to the recycling structure of the light source module 1. Therefore, high brightness can be attained. Also, an image projection apparatus with an image forming device using polarization such as a transmissive LCD or a reflective LCD (e.g., LCOS) can provide a sufficiently bright image by employing the light source module 1 as an illumination light source.

In this embodiment, the light source module 1 includes the parabolic reflection mirror. Alternatively, the light source module 1 may include an elliptic reflection mirror. In this alternative case, the light-emitting chip 3 may be located on or near one focal point of the elliptic reflection mirror, the lens 7a of the lens plate 7 may be formed to converge the incident diverging light, and a lens system (not shown) may be further included in the light source module 1 at an exit end of the elliptic reflection mirror to collimate the converged light or collimate the light after the converged light is diverged. The structure of the alternative light source module can be easily understood by those of ordinary skill in the art from this description. Thus, detail descriptions and drawings thereof will be omitted.

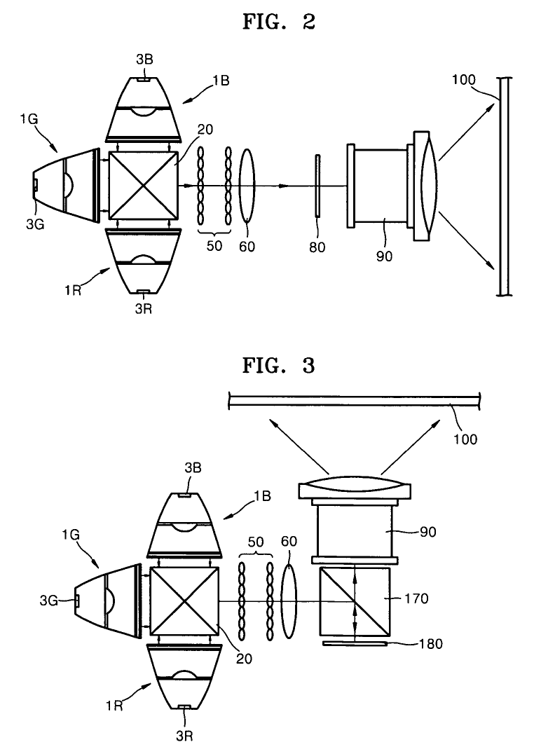

FIG. 2 shows an embodiment of an image projection apparatus employing the light source module 1 depicted in FIG. 1 as an illumination light source.

Referring to FIG. 2, an image projection apparatus according to an embodiment of the present invention includes a first light source module 1R, a second light source module 1G, a third light source module 1B, an image forming device 80, and a projection lens unit 90. The image forming device 80 forms an image corresponding to an input image signal by receiving light from the three light source modules 1R, 1G, and 1B. The projection lens unit 90 projects the image formed by the image forming device 80 to a screen on an enlarged scale.

The first through third light source modules 1R, 1G, and 1B are provided to illuminate light in different colors. For example, the first light source module 1R may include a red light-emitting chip 3R to emit red light, the second light source module 1G may include a green light-emitting chip 3G to emit green light, and the third light source module 1B may include a blue light-emitting chip 3B to emit blue light. The light source module 1 depicted in FIG. 1 can be used for the light source modules 1R, 1G, and 1B.

The image projection apparatus may further include a color synthesis prism 20 such as an X-cube prism to combine the color light emitted from the light source modules 1R, 1G, and 1B to direct it in a single optical path. That is, the red, green, and blue light beams from the light source modules 1R, 1G, and 1B are incident into the color synthesis prism 20, and they are combined and directed to the same optical path by the color synthesis prism 20.

Alternatively, the image projection apparatus according to an embodiment of the present invention may include a single light source module with a light-emitting chip emitting white light. In this case, the color synthesis prism 20 is not required. That is, the image projection apparatus according to an embodiment of the present invention can include at least one light source module. The number of the light source module may vary according to applications.

The image projection apparatus may further include a light integrator 50 to homogenize the light emitted from the light source modules 1R, 1G, and 1B and combined by the color synthesis prism 20. The light integrator 50 may be a pair of fly eye lenses shown in FIG. 2. The fly eye lenses respectively include a lens cell array with a plurality of convex or cylindrical lens cells.

The image projection apparatus may further include a relay lens 60 across the optical path between the light integrator 50 and the image forming device 80 to enlarge or reduce the light beam emitted from the light integrator 50 depending on an effective area of the image forming device 80.

The image forming device 80 forms an image by control of incident uniform illumination light in pixel unit. The image forming device 80 may be a transmissive LCD. The transmissive LCD forms an image by selectively turning on or off transmission light by changing the polarization of incident uniform illumination light in pixel unit according to an image signal.

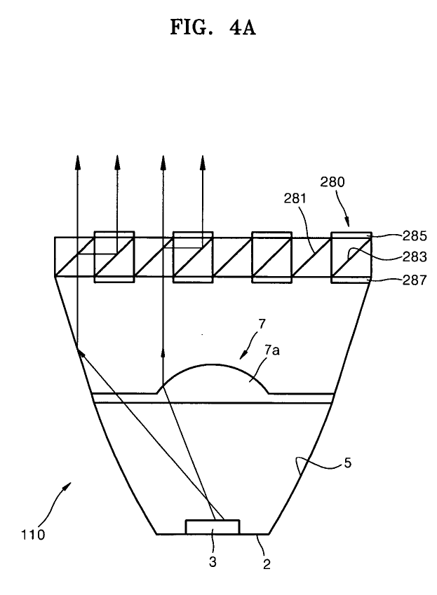

FIG. 3 shows an image projection apparatus according to another embodiment of the present invention, in which a reflective image forming device 180 is included instead of the transmissive image forming device 80 depicted in FIG. 2. Same elements in FIGS. 2 and 3 are denoted by the same reference numerals, and their description will be omitted.

Referring to FIG. 3, an image projection apparatus according to another embodiment of the present invention includes the image forming device 180, such as a reflective LCD (e.g., LCOS). The reflective LCD forms an image by selectively reflecting incident uniform illumination light in its pixel unit. That is, the reflective LCD forms an image by selectively turning on or off reflected light by changing the polarization of incident light in pixel unit according to an image signal.

When the reflective LCD is used for the image forming device 180, the image projection apparatus may further include a polarization-selecting optical path changer, such as a polarizing beam splitter 170, to transmit or reflect incident light according to polarization. The polarization beam splitter 170 changes the optical path by directing one polarized light from the light source modules 1R, 1G, and 1B toward the reflective LCD and directing other polarized light reflected from the reflective LCD toward the projection lens unit 90.

As shown in FIGS. 2 and 3, for the image projection apparatus with image forming device utilizing the polarization, such as a transmissive LCD and a reflective LCD (e.g., LCOS), the light source module 1 according to an embodiment of the present invention can be used as an illumination light source. The image projection apparatus can form a sufficiently bright picture by employing the light source module 1.

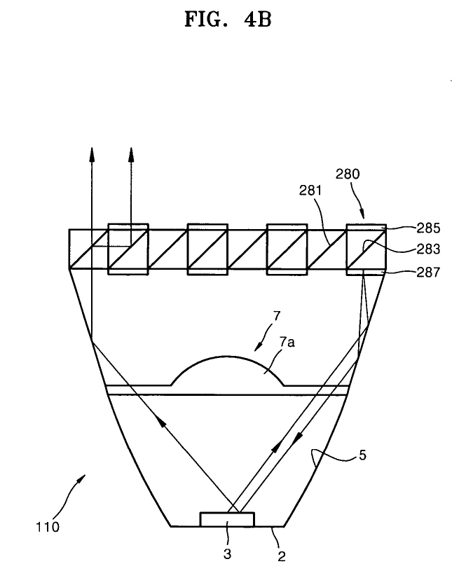

FIGS. 4A and 4B are schematic views showing a structure of a light source module 110 according to another embodiment of the present invention. The light source module 110 of this embodiment has substantially the same structure as the light source module 1 shown in FIG. 1, except that it has a polarization alignment unit 280 different from the polarization alignment unit 8 shown in FIG. 1.

Referring to FIGS. 4A and 4B, the light source module 110 includes the polarization alignment unit 280. The polarization alignment unit 280 includes a plurality of small polarizing beam splitters 281, a plurality of reflectors 283 arranged adjacent to each of the plurality of the small polarizing beam splitters 281 to form an array structure with the polarizing beam splitters 281, a plurality of half wave plates 285 respectively placed on output surfaces of the reflectors 283, and a plurality of reflecting plates 287 respectively placed on surfaces of the reflectors 283 to face the light-emitting chip 3. The polarization alignment unit 280 is coupled to the exit end of the reflection mirror 5.

The small polarizing beam splitter 281 selectively transmits or reflects incident light based on the polarization of the incident light. The reflector 283 reflects the light reflected from the small polarizing beam splitter 281 in a direction parallel with the light transmitted through the small polarizing beam splitter 281. The half wave plate 285 changes the polarization of the light reflected from the reflector 283 to make it equal to that of the light transmitted through the small polarizing beam splitter 281. For example, in the case where S (or P) polarized light passes through the small polarizing beam splitter 281 and P (or S) polarized light is reflected by the small polarizing beam splitter 281, the half wave plate 285 converts the P (or S) polarized light into S (or P) polarized light. Therefore, the polarization alignment unit 280 can output light polarized in one direction.

The plurality of reflecting plates 287 reflect light directed directly to the reflector 283 to feed back the light. By the existence of the reflecting plate 287 and the array structure according to the alternate arrangement of the small polarizing beam splitters 281 and the reflectors 283, the whole light emitted from the light-emitting chip 3 can be polarized in one direction and output without loss due to polarization.

The arrangement distance of the plurality of reflecting plates 287, which is obtained from the array structure according to the alternate arrangement of the small polarizing beam splitters 281 and the reflectors 283, may be optimally designed to maximize the ratio of the light fed back by reflecting from the reflecting plates 287 which is reflected by the light-emitting chip 3 and then travels toward the region where the small polarizing beam splitters 281 is located. This is because amount of reflected light is reduced according to increasing of feed back times.

In the light source module 110 as described above, the light, which is emitted from the light-emitting chip 3 and is changed as an straight light by reflection from the reflection mirror 5 or refraction through the lens 7a of the lens plate 7 and then travels toward the region where the small polarizing beam splitter 281 is located, is directly polarized in one direction by the polarization alignment unit 280 and output from the light source module 110, as shown in FIG. 4A.

The light, which is emitted from the light-emitting chip 3 and reflected by the reflection mirror 5 toward the reflecting plate 287, is fed back by the reflecting plate 287 as shown in FIG. 4B. The fed back light is directed to region where the small polarizing beam splitter 281 is located after being reflected by one portion of the reflection mirror 5, the light-emitting chip 3 (or the base 2), and the other portion of the reflection mirror 5 in order. The light is polarized in one direction by the polarization alignment unit 280 and output from the light source module 110.

The fed back light of the light that is emitted from the light-emitting chip 3 and directly enters the lens 72 of the lens plate 7 and thus are refracted into straight light travels as follows. The light, which is changed to be straight light through refraction by the lens 7a and then travels toward region where the reflecting plate 287 is located, is fed back by being reflected from the reflecting plate 287. The fed back light is directed to light-emitting chip 3 (or the base 2) through reverse proceeding and reflected therefrom. Most of the reflected light is directed toward the polarizing beam splitter 281 after being refracted by the lens 7a. Then, the light is polarized in one direction by the polarization alignment unit 280 and output from the light source module 110.

Here, some of the fed back light may be forwarded again to the reflecting plate 287 to repeat the feedback. The less the light is repeated in the feedback operation, the more the light can be output from the light source module 110.

In another embodiment according to the present invention, the light source module 110 may include elliptic reflection mirror instead of the parabolic reflection mirror.

In this case, the light-emitting chip 3 may be located on or near either of the focal points of the elliptic reflection mirror, the lens 7a of the lens plate 7 may be formed to converge the incident diverging light, and a lens system (not shown) may be further included in the light source module 110 at an exit end of the elliptic reflection mirror to collimate the converged light or collimate the light after the converged light is diverged. The structure of the alternative light source module can be easily understood by those of ordinary skill in the art from this description. Thus, detail descriptions and drawings thereof will be omitted.

According to this embodiment, polarized and collimated light can be obtained from the non-polarized diverging light emitted from the light-emitting chip 3 at an efficiency of at least 50% (ideally, 100%) owing to the recycling structure of the light source module 110. Therefore, high brightness can be attained.

Therefore, for the image projection apparatus with image forming device utilizing the polarization, such as a transmissive LCD and a reflective LCD (e.g., LCOS), as shown in FIGS. 2 and 3, the light source module 110 can be used as an illumination light source. The image projection apparatus can form a sufficiently bright picture by employing the light source module 110. Embodiments of applying the light source module 110 to the image projection apparatus with image forming device utilizing the polarization can be easily understood by those of ordinary skill in the art from above description. Thus, detail descriptions and drawings thereof will be omitted.

According to the present invention, the light source module produces collimated and polarized light, such that the image projection apparatus with image forming device utilizing the polarization can be operated without light loss resulted from the polarization property of the image forming device by employing the light source module as a light source. Therefore, the image projection apparatus can form a sufficiently bright picture.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A light source module comprising:
a light-emitting chip installed on a base to generate and emit illuminating light and having reflectivity to reflect light incident thereto;
a reflection mirror coupled with the base to reflect the light coming from the light-emitting chip toward a front direction; and
a polarization alignment unit installed on an exit end of the reflection mirror to feed back a portion of light incident on the polarization alignment unit by reflection and to polarize the light coming from the light-emitting chip in one direction and output the polarized light,
wherein the fed back light of the light incident on the polarization alignment unit is reflected back to the polarization alignment unit by at least one of the reflection mirror and the base.

2. The light source module of claim 1, further comprising a lens plate installed between the polarization alignment unit and the light-emitting chip and having a lens at a center portion across an optical path along which some of the light from the light-emitting chip is directly directed to the polarization alignment unit.

3. The light source module of claim 2, wherein the lens is a convex lens with a focal point on or near a surface of the light-emitting chip, and the lens plate is made of a transparent material.

4. The light source module of claim 3, wherein the reflection mirror has a parabolic shape and the light-emitting chip is placed at or near a focal point of the reflection mirror.

5. The light source module of claim 4, wherein the light-emitting chip is one light-emitting chip selected from a single light-emitting chip with a normal surface size, a chip array with a plurality of light-emitting chips each having a normal surface size, and a single light-emitting chip with a surface size relatively larger than the normal surface size.

6. The light source module of claim 1, wherein the reflection mirror has a parabolic shape and the light-emitting chip is placed at or near a focal point of the reflection mirror.

7. The light source module of claim 1, wherein the light-emitting chip is one light-emitting chip selected from a single light-emitting chip with a normal surface size, a chip array with a plurality of light-emitting chips each having a normal surface size, and a single light-emitting chip with a surface size relatively larger than the normal surface size.

8. The light source module of claim 1, wherein a surface of the base facing the exit end of the reflection mirror is a reflective surface.

9. The light source module of claim 1, wherein the polarization alignment unit comprises:
a polarizing plate placed at an exit end of the reflection mirror to pass a first linear polarization component of light incident on the polarization plate and to feed back a second linear polarization component of the light incident on the polarization plate that is orthogonal to the first linear polarization component; and
a quarter wave plate placed between the light-emitting chip and the polarizing plate to change the polarization of light incident on the quarter wave plate.

10. The light source module of claim 1, wherein the polarization alignment unit comprises:
a plurality of polarizing beam splitters to selectively transmit or reflect light incident on the polarizing beam splitters based on polarization of the light incident on the polarizing beam splitters;
a plurality of reflectors respectively placed near the polarizing beam splitters to form an array structure with the polarizing beam splitters, the reflectors reflecting the light reflected from the polarizing beam splitter to direct the light reflected from the polarizing beam splitter in a parallel direction with the light transmitted through the polarizing beam splitter;
a plurality of half wave plates respectively placed on output surfaces of the reflectors to change the polarization of the light reflected from the reflectors; and
a plurality of reflecting plates respectively placed on surfaces of the reflectors to face the light-emitting chip, the reflecting plates feeding back light incident on the reflecting plates.

11. An image projection apparatus comprising:
at least one light source module;
an image forming device utilizing polarization receiving light illuminated from the light source module to form an image corresponding to an input image signal; and
a projection lens unit projecting the image formed by the image forming device to a screen on an enlarged scale,
wherein the light source module comprises:
a light-emitting chip installed on a base to generate and emit light and having reflectivity to reflect light incident thereto;
a reflection mirror coupled with the base to reflect the light coming from the light-emitting chip toward a front direction; and
a polarization alignment unit installed on an exit end of the reflection mirror to feed back a portion of light incident on the polarization alignment unit by reflection and to polarize the light coming from the light-emitting chip in one direction and output the polarized light, wherein the fed back light of the light incident on the polarization alignment unit is reflected back to the polarization alignment unit by at least one of the reflection mirror and the base.

12. The image projection apparatus of claim 11, wherein the light source module further includes a lens plate installed between the polarization alignment unit and the light-emitting chip and having a lens at a center portion across an optical path along which some of the light from the light-emitting chip is directly directed to the polarization alignment unit.

13. The image projection apparatus of claim 12, wherein the lens is a convex lens with a focal point on or near a surface of the light-emitting chip, and the lens plate is made of a transparent material.

14. The image projection apparatus of claim 13, wherein the reflection mirror has a parabolic shape and the light-emitting chip is placed at or near a focal point of the reflection mirror.

15. The image projection apparatus of claim 14, wherein the light-emitting chip is one light-emitting chip selected from a single light-emitting chip with a normal surface size, a chip array with a plurality of light-emitting chips each having a normal surface size, and a single light-emitting chip with a surface size relatively larger than the normal surface size.

16. The image projection apparatus of claim 11, wherein the reflection mirror has a parabolic shape and the light-emitting chip is placed at or near a focal point of the reflection mirror.

17. The image projection apparatus of claim 11, wherein the light-emitting chip is one light-emitting chip selected from a single light-emitting chip with a normal surface size, a chip array with a plurality of light-emitting chips each having a normal surface size, and a single light-emitting chip with a surface size relatively larger than the normal surface size.

18. The image projection apparatus of claim 11, wherein a surface of the base facing the exit end of the reflection mirror is a reflective surface.

19. The image projection apparatus of claim 11, wherein the polarization alignment unit comprises:
a polarizing plate placed at an exit end of the reflection mirror to pass a first linear polarization component of light incident on the polarizing plate and to feed back a second linear polarization component of the light incident on the polarizing plate that is orthogonal to the first linear polarization component; and
a quarter wave plate placed between the light-emitting chip and the polarizing plate to change the polarization of light incident on the quarter wave plate.

20. The image projection apparatus of claim 19, wherein a plurality of light source modules is provided to output light in different colors, the apparatus further comprising:
a color synthesis prism combining the color light output from the light source modules to direct the combined light in a single optical path; and
a light integrator homogenizing the light output from the light source modules.

21. The image projection apparatus of claim 11, wherein polarization alignment unit comprises:
a plurality of polarizing beam splitters selectively transmitting or reflecting light incident on the polarizing beam splitters based on polarization of the light incident on the polarizing beam splitters;
a plurality of reflectors respectively placed near the polarizing beam splitters to form an array structure with the polarizing beam splitters, the reflectors reflecting the light reflected from the polarizing beam splitter to direct the light in a parallel direction with the light transmitted through the polarizing beam splitter;
a plurality of half wave plates respectively placed on output surfaces of the reflectors to change the polarization of the light reflected from the reflectors; and
a plurality of reflecting plates respectively placed on surfaces of the reflectors to face the light-emitting chip, the reflecting plates feeding back light incident on the reflecting plates.

22. The image projection apparatus of claim 21, wherein a plurality of light source modules is provided to output light in different colors, the apparatus further comprising:
a color synthesis prism combining the color light output from the light source modules to direct the combined light in a single optical path; and
a light integrator homogenizing the light output from the light source modules.

23. The image projection apparatus of claim 11, wherein the image forming device is a reflective liquid crystal display (LCD), the apparatus further comprising a polarization-selecting optical path changer disposed between the light source module and the reflective LCD to selectively transmit or reflect light incident on the polarization-selecting optical path changer based on polarization of the light incident on the polarization-selecting optical path changer so as to direct the light from the light source module toward the reflective LCD and to direct light with image information reflected from the reflective LCD toward a screen.

24. The image projection apparatus of claim 11, wherein the image forming device is a transmissive LCD.

25. The image projection apparatus of claim 11, wherein a plurality of light source modules is provided to output light in different colors, the apparatus further comprising:
a color synthesis prism combining the color light output from the light source modules to direct the combined light in a single optical path; and
a light integrator homogenizing the light output from the light source modules.

26. The image projection apparatus of claim 25, wherein the light integrator includes a pair of fly eye lenses.
